(19) United States
(12) Patent Application Publication
(10) Pub. No.: US 2009/0250231 A1
(43) Pub. Date: Oct. 8, 2009

(54) Equipment for use in rescue service for making holes in roof etc by cutting

(76) Inventor: Lars G. Larsson, Saro (SE)

Correspondence Address: HARNESS, DICKEY & PIERCE, P.L.C., P.O. BOX 8910, RESTON, VA, 20195, US

(21) Appl. No.: 11/990,857

(22) PCT Filed: Sep. 5, 2006
(86) PCT No.: PCT/SE2006/001013

§ 371 Date: Feb. 22, 2008

(30) Foreign Application Priority Data
Sep. 13, 2005 (SE) 0502015-1

(51) Int. Cl. A62C 31/22; A62C 13/00; A62C 17/00

(52) U.S. Cl. 169/70; 83/177; 169/30; 169/15; 451/99

(57) ABSTRACT

In one embodiment of the present invention, equipment for making holes by cutting in walls etc. is disclosed in case of fire in spaces in buildings etc. for fire fighting. The equipment includes a vehicle-mounted pressure source for pressurised extinguishing liquid, a lance carried by the operator with his hands and provided with an extinguishing nozzle, and a tubing between the pressure source and the extinguishing nozzle for supplying the extinguishing liquid. The extinguishing liquid flows as a jet out of the extinguishing nozzle and towards the wall etc. to cut the wall for making the hole and, when cutting through, be injected into the space on fire and extinguish the fire. The equipment also includes a vessel carried by the operator on his back and containing an additive, the vessel being connected to the extinguishing nozzle for regulated supply of the additive to the extinguishing liquid for improving the cutting and/or extinguishing effect.

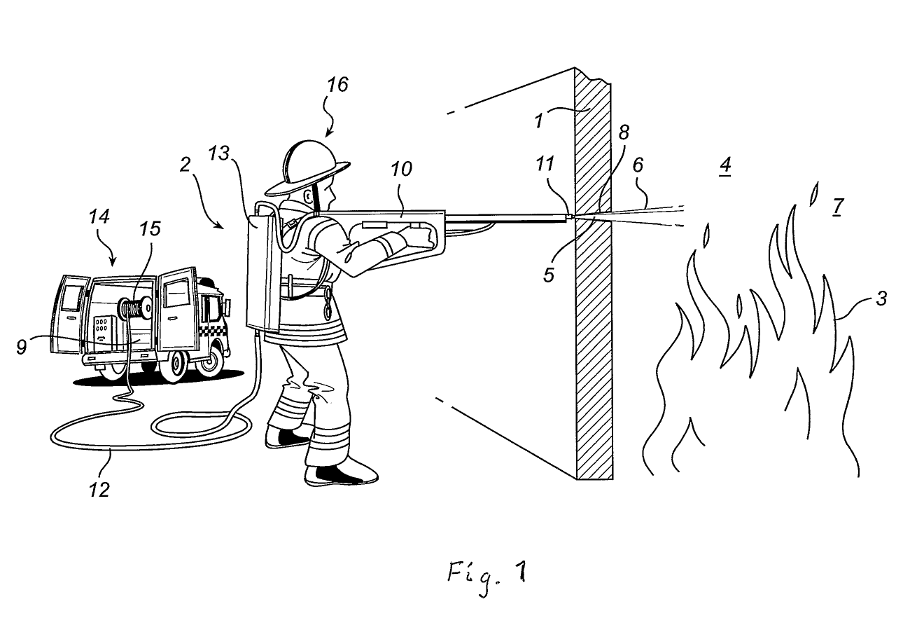

### FIELD OF THE INVENTION

This invention relates to equipment in rescue service for making holes by cutting in roofs, walls, doors etc. in case of fire in spaces in constructions such as different types of buildings, cisterns, tanks and containers for various purposes and vehicles, trains, ships etc. for fire fighting, which equipment comprises a pressure source for supplying a pressurised extinguishing liquid; a portable lance with an extinguishing nozzle; a tubing between the pressure source and the extinguishing nozzle for supplying the extinguishing liquid, the extinguishing liquid substantially in the form of a jet being made to flow out of the extinguishing nozzle and towards the roof, wall, door etc. to cut through the same for making a hole and, when cutting through, being injected into the space on fire and thus helping to extinguish the fire; and a vessel which contains an additive and is connected to the extinguishing nozzle for regulatable supply of the additive to the extinguishing liquid in order to improve the cutting and/or extinguishing effect.

### BACKGROUND ART

In fire fighting, holes are today still made by means of hand tools such as an axe or crowbar, angle grinder and/or cutting machine etc. Newer equipment involves blast frames for blasting a hole. Such blast frames are, however, to be used once and relatively expensive. The explosive contained in them imposes stringent security requirements for storing and handling.

In recent years, completely new equipment of the type as defined above and in the preamble to claim 1 has been developed. Such equipment, which is usually called cutting extinguisher, is shown and described in terms of basic construction and function in SE-C2-509 895.

With this new equipment and its unique high pressure system, a fire will be extinguished very effectively. The extinguishing nozzle disperses the extinguishing liquid into microdroplets, and a very fine mist is formed, which quickly cools the fire gases. The jet produced by the extinguishing liquid, with abrasive added, penetrates all types of building materials—roof, walls, doors etc. —into the space on fire. This means that the fire centre will be quickly reached, and that the fire can be attacked without making openings and thus supplying new oxygen.

Of the main components included in the equipment, the pressure source and the vessel for the additive, usually an abrasive, are normally fixedly mounted on or in a fire fighting vehicle, plus a roll for unwinding and winding the tubing and an attachment for storing the lance when not in use.

In operation, the tubing with the lance mounted is unwound and pulled out to the place of fire where the lance operator, usually a fireman, performs the making of the hole and fire fighting. For the lance operator to be able to perform this work, at least one more operator adjacent to the fire fighting vehicle must activate/connect the pressure source and regulate the supply of the additive as desired and required by the lance operator.

In many situations, it may be experienced as inconvenient that the lance operator cannot have the desired regulation of the supply of the additive made sufficiently quickly and accurately but must communicate with the operator adjacent to the fire fighting vehicle, with the risk of time delay and misunderstanding.

### OBJECT OF THE INVENTION

The main object of the invention is to obviate the above inconvenience and make it possible for the lance operator himself quickly, effectively and accurately to be able to regulate, in a simple and convenient manner, the supply of the additive as desired and required.

### SUMMARY OF THE INVENTION

This object is achieved in a manner that is as simple as ingenious by the vessel with the additive being portable.

In a specially preferred embodiment, both the lance and the vessel are carried by the operator, in which case he preferably carries the lance with his hands and the vessel on his back. In another preferred embodiment, the vessel may alternatively be fixedly or detachably mounted on the actual lance, in which case the operator then suitably carries both the lance and the vessel with his hands.

As a rule and preferably, the additive in the vessel is an abrasive for improving the cutting effect in the actual making of the hole. Alternatively or as a compliment, the additive may be an extinguishing foam or an extinguishing powder for improving the cutting effect. Of course, it would be possible to use different such additives at the same time or in succession.

### BRIEF DESCRIPTION OF THE DRAWING

The invention will now be described in more detail with reference to the accompanying drawing, which schematically and in perspective illustrates a currently specially preferred embodiment.

### DETAIL DESCRIPTION OF THE PREFERRED EMBODIMENT

When making a hole by cutting in a roof, walls 1, doors etc. using the equipment according to the invention generally designated 2 in case of fire 3 in spaces 4 in such constructions as different types of buildings, cisterns, tanks and containers for various purposes and vehicles, trains, ships etc. for fire fighting, this making of the hole by cutting occurs by means of a pressurised extinguishing liquid 5 which during cutting is injected into the space 4 on fire in the form of a jet 6, which is quickly evaporated and assists in extinguishing the fire 3, whereby formed fire gases 7 can effectively be passed out through the cut-up hole.

The extinguishing liquid 5 is usually ordinary water to which one or more liquid and/or pulverulent additives 8 are added to improve the cutting and/or extinguishing effect. Such an additive 8 is an abrasive, for example a sandblasting agent with sand or some other abrasive material, which increases the cutting speed through the wall 1 etc. Another additive can be an extinguishing foam or an extinguishing powder or the like, which during injection of the extinguishing liquid 5 into the space 4 on fire in combination with the simultaneously formed fine mist quickly cools the fire gases 7 and, thus, additionally promotes the effective fire fighting.

The equipment 2 according to the invention as illustrated in the drawing comprises as main components a pressure source 9 for providing the pressurised extinguishing liquid 5; a lance 10 with an extinguishing nozzle 11 for discharging the extinguishing liquid; a tubing 12 between the pressure source 9 and the extinguishing nozzle 11 for supplying the extinguishing liquid 5; and a vessel 13 which contains an additive 8 such as an abrasive to be added to the extinguishing liquid.

In the shown preferred embodiment, the pressure source 9 is suitably a high pressure pump fixedly mounted in a fire fighting vehicle 14. To the outlet of the high pressure pump, the tubing 12 is connected, which preferably is arranged to be unwound from and wound onto a reel which is suitably also mounted in the fire fighting vehicle 14. At its other end, the tubing 12 is connected to the lance 10 and its extinguishing nozzle 11 via the vessel 13 containing the additive 8.

The lance 10 and the associated extinguishing nozzle 11 is supported and operated by an operator, usually a fireman, to perform the making of the hole and the fire fighting.

For the operator 16 to be quickly, effectively and accurately able himself to regulate, in a simple and convenient manner, the supply of the additive 8 to the extinguishing liquid 5 as desired and required, the vessel 13 is portable to be positioned close to the operator 16 in fire fighting. In the shown preferred embodiment, the operator also carries the vessel 13, in which case he preferably carries the lance 10 with his hands and the vessel on his back. Alternatively, the vessel 13 can be fixedly or detachably mounted directly on the lance 10, in which case the operator 16 suitably carries the unit consisting of the lance and the vessel with his hands.

Independently of the location of the vessel 13 on the operator's back, on the lance or in some other place close to the operator 16, he can, by actuating means (not shown) adjacent to the vessel and/or the lance, himself perform the regulation of the supply of the additive 8 to the extinguishing liquid 5 simultaneously or in connection with the making of the hole and/or the fire fighting.

Of course, the invention must not be considered to be limited to the shown and described embodiment and the alternatives mentioned, but can be modified and supplemented optionally within the scope of the appended claims.

1. Equipment in rescue service for cutting at least one hole in an object for fire fighting, the equipment comprising:
a pressure source to supply pressurized extinguishing liquid;
a portable lance including an extinguishing nozzle;
a tubing, between the pressure source and the extinguishing nozzle, to supply the extinguishing liquid, the extinguishing liquid substantially being in a form of a jet being made to flow out of the extinguishing nozzle and towards the roof object to cut through the object and make a hole and, when cutting through, being injected into the fire, and thus helping to extinguish the fire; and
a vessel containing an additive and connected to the extinguishing nozzle for regulatable supply of the additive to the extinguishing liquid to improve at least one of the cutting and extinguishing effect, the vessel being portable.

2. Equipment as claimed in claim 1, wherein the lance and the vessel are carried by an operator.

3. Equipment as claimed in claim 2, wherein the operator carries the lance with his hands and the vessel on his back.

4. Equipment as claimed in claim 2, wherein the vessel is arranged on the lance and the operator carries the lance and the vessel with his hands.

5. Equipment as claimed in claim 1, wherein the additive in the vessel is an abrasive for improving the cutting effect.

6. Equipment as claimed in claim 1, wherein the additive in the vessel is at least one of an extinguishing foam and an extinguishing powder for improving the extinguishing effect.

7. Equipment as claimed in claim 2, wherein the additive in the vessel is an abrasive for improving the cutting effect.

8. Equipment as claimed in claim 3, wherein the additive in the vessel is an abrasive for improving the cutting effect.

9. Equipment as claimed in claim 4, wherein the additive in the vessel is an abrasive for improving the cutting effect.

10. Equipment as claimed in claim 2, wherein the additive in the vessel is at least one of an extinguishing foam and an extinguishing powder for improving the extinguishing effect.

11. Equipment as claimed in claim 3, wherein the additive in the vessel is at least one of an extinguishing foam and an extinguishing powder for improving the extinguishing effect.

12. Equipment as claimed in claim 4, wherein the additive in the vessel is at least one of an extinguishing foam and an extinguishing powder for improving the extinguishing effect.
